(19) United States
(12) Patent Application Publication
(10) Pub. No.: US 2022/0287530 A1
(43) Pub. Date: Sep. 15, 2022

(54) Method and Apparatus for Localizing Mobile Robot in Environment

(71) Applicant: Midea Group Co., Ltd., Foshan (CN)

(72) Inventors: Wei XI, San Jose, CA (US); Xiuzhong WANG, San Jose, CA (US)

(21) Appl. No.: 17/202,268

(22) Filed: Mar. 15, 2021

(51) Int. Cl. A47L 11/40; B25J 9/16; B25J 13/08

(52) U.S. Cl. CPC A47L 11/4011; B25J 9/1697; B25J 13/089; B25J 9/1653; B25J 11/0085

(57) ABSTRACT

The method and system disclosed herein presents a method and system for capturing, by a camera moving in an environment, a sequence of consecutive frames at respective locations within a portion of the environment; constructing a topological semantic graph corresponding to the portion of the environment based on the sequence of consecutive frames; in accordance with a determination that the topological semantic graph includes at least a predefined number of edges: searching, in a topological semantic map of the environment, one or more candidate topological semantic graphs corresponding to the first topological semantic graph; for a respective candidate topological semantic graph of the one or more candidate topological semantic graphs, searching, in a joint semantic and feature localization map, a keyframe corresponding to the respective candidate topological semantic graph; and computing a current pose of the camera based on the keyframe.

### FIELD OF THE TECHNOLOGY

The present disclosure generally relates to the technology of simultaneous localization and mapping (SLAM) in an environment, and in particular, to systems and methods for characterizing physical environments and localizing a mobile robot with respect to its environment using image data.

### BACKGROUND OF THE TECHNOLOGY

Localization, place recognition, and environment understanding are key capabilities to enable a mobile robot to become a fully autonomous or semi-autonomous system in an environment. Simultaneous localization and mapping (SLAM) is a method that builds a map of an environment and simultaneously estimates the pose of a mobile robot (e.g., using the estimated pose of its cameras) in the environment. SLAM algorithms allow the mobile robot to map out unknown environments and localize itself in the environment to carry out tasks such as path planning and obstacle avoidance. Traditional localization methods include using visual categorization algorithms for image-to-image matching, such as a bag of words (BoW) model, to encode visual features from images captured of the environment to binary descriptors (e.g., codewords). A discriminative model such as support vector machine (SVM) can then be used on the encoded visual features for relocalization and object recognition tasks. However, the performance and computational cost of the existing BoW and SVM methods can be poor, and more efficient and accurate methods are needed.

### SUMMARY

One disadvantage of using the BoW model is that this method ignores the spatial relationship among various objects captured on an image. When the mobile robot is navigating a complex environment with a large number of obstacles and objects, the localization success rate can be poor, and the computational cost may increase significantly leading to delayed responses. As a result, more efficient methods and systems for localizing a mobile robot in a complex environment based on visual data, such as current and/or real-time camera image data, are highly desirable.

As disclosed herein, one solution relies on using a joint semantic and feature map of the environment to localize the mobile robot in a two-step process. At the first step, the system creates a local semantic map (e.g., a topological graph with vertices representing semantic information of objects located in a portion of the environment) that represents a current portion of the environment surrounding the mobile robot (e.g., by capturing images surrounding the robot and processing the images into topological graphs with object semantic information). The system then identifies similar topological graphs in a global semantic map of the environment as localization candidates. The global semantic map is pre-constructed to represent the entire environment in which the mobile robot navigates, and the topological graphs are parts of the global semantic map that represent respective portions of the environment with similar topological information to those of the current portion of the environment. At the second step, after the candidate topological graphs are identified, the system uses keyframe-based geometric verification and optimization methods for fine-grained localization of the mobile robot. Such a two-step localization process based on a joint semantic and feature map provides faster and more accurate localization results in a complex environment, comparing to methods relying exclusively the BoW method, because topological information of the environment (e.g., from the semantic maps) is used in addition to the visual features obtained from the BoW method.

The global semantic map and information from the keyframes are part of the joint semantic and feature map. The joint semantic and feature map encodes multi-level object information as well as object spatial relationships via topological graphs.

According to a first aspect of the present application, a method of localizing a mobile robot includes: capturing, by a camera moving in an environment, a sequence of consecutive frames at respective locations within a portion of the environment; constructing a first topological semantic graph corresponding to the portion of the environment based on the sequence of consecutive frames; and in accordance with a determination that the topological semantic graph includes at least a predefined number of edges: searching, in a topological semantic map of the environment, one or more candidate topological semantic graphs corresponding to the first topological semantic graph; for a respective candidate topological semantic graph of the one or more candidate topological semantic graphs, searching, in a joint semantic and feature (e.g., keypoints, lines, etc.) localization map, for a keyframe corresponding to the respective candidate topological semantic graph, wherein the keyframe captures objects in the environment corresponding to nodes of the respective candidate topological semantic graph; and computing a current pose of the camera based on the keyframe.

In some embodiments, the topological semantic graph comprises: a plurality of nodes with a respective node corresponding to a representation of an object located in the portion of the environment, wherein the object is captured and recognized from the sequence of consecutive frames; and a plurality of edges with a respective edge connecting two respective nodes of the plurality of nodes, wherein the two respective nodes connected by the respective edge correspond to two respective objects captured and recognized on a same frame of the sequence of consecutive frames. In some embodiments, the topological semantic map of the environment includes semantic information of the environment, and each of the one or more candidate topological semantic graphs is a connected subgraph of the topological semantic map.

In some embodiments, computing the current pose of the camera based on the keyframe includes comparing a plurality of features (e.g., keypoints, lines) on the sequence of consecutive frames to a plurality of three-dimensional map points of the environment corresponding to the keyframe; and determining the current pose of the camera based on a result of the comparing and known camera poses associated with the plurality of three-dimensional map points of the environment.

According to a second aspect of the present application, an electronic device includes one or more processors, memory and a plurality of programs stored in the memory. The programs include instructions, which when executed by the one or more processors, cause the electronic device to perform the methods described herein.

According to a third aspect of the present application, a non-transitory computer readable storage medium stores a plurality of programs for execution by an electronic apparatus having one or more processors. The programs include instructions, which when executed by the one or more processors, cause the electronic device to perform the methods described herein.

In addition to reducing computation complexity, and improving speed and accuracy of localization of mobile robots in an environment, as described above, various additional advantages of the disclosed technical solutions are apparent in light of the descriptions below.

### BRIEF DESCRIPTION OF THE DRAWINGS

The aforementioned features and advantages of the disclosed technology as well as additional features and advantages thereof will be more clearly understood hereinafter as a result of a detailed description of preferred embodiments when taken in conjunction with the drawings.

To describe the technical solutions in the embodiments of the present disclosed technology or in the prior art more clearly, the following briefly introduces the accompanying drawings required for describing the embodiments or the prior art. Apparently, the accompanying drawings in the following description show merely some embodiments of the present disclosed technology, and persons of ordinary skill in the art may still derive other drawings from these accompanying drawings without creative efforts.

FIG. 1 is a schematic diagram of a layout of an environment in which a mobile robot navigates in accordance with some embodiments.

FIG. 2 is a schematic diagram of a co-visibility graph created in accordance with images captured from the vantage point of a mobile robot navigating in an environment in accordance with some embodiments.

FIG. 3 is a flow diagram illustrating an exemplary process of building a semantic map of an environment using camera data in accordance with some embodiments.

FIG. 4 illustrates an exemplary semantic map including multiple semantic graphs that correspond to different portions of an environment in accordance with some embodiments.

FIG. 5 illustrates an exemplary image including both identified semantic objects and keypoints in accordance with some embodiments.

FIG. 6 illustrates an exemplary joint semantic and keypoint localization map in accordance with some embodiments.

FIG. 7 is a flow diagram illustrating an exemplary process of localizing a mobile robot in an environment using a joint semantic and keypoint localization map in accordance with some embodiments.

FIG. 8 illustrates an exemplary topology graph matching scheme for localizing a mobile robot in an environment in accordance with some embodiments.

FIG. 9 illustrates an exemplary comparison of a captured image and a corresponding keyframe from a keyframe database for localizing a mobile robot in an environment in accordance with some embodiments.

FIG. 10 illustrates an exemplary flowchart for a process of localizing a mobile robot in an environment in accordance with some embodiments.

FIG. 11 is a block diagram of an electronic device that is configured to perform the methods described herein, in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

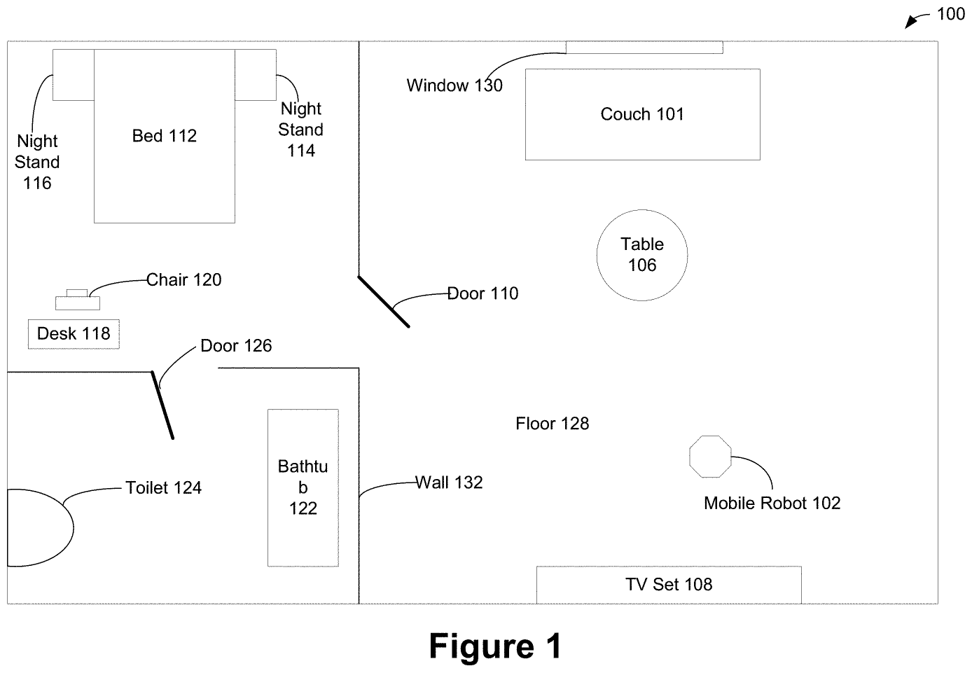

FIG. 1 is a schematic diagram of a layout of an exemplary environment 100 in which a mobile robot navigates in accordance with some embodiments. In FIG. 1, for example, the environment 100 is an indoor environment including a number of connected rooms separated by walls. The environment 100 includes both structural objects (e.g., window 130, floor 128, doors 110 and 126, and wall 132) and non-structural objects (e.g., couch 101, table 106, TV set 108, bed 112, night stands 114 and 116, chair 120, desk 118, toilet 124, and bathtub 122). In some embodiments, the environment 100 is an outdoor environment, and optionally includes both structural objects (e.g., buildings, landmarks, streets, etc.) and non-structural objects (e.g., trees, mailboxes, street signs, cars, picnic tables, tents, etc.). In some embodiments, the environment 100 (or portions of the environment 100) is digitally captured (e.g., by RGB color cameras, black and white cameras, infrared cameras, depth cameras, etc.) and the structural and non-structural objects are detected and identified as semantic objects from the captured images using various image processing and object segmentation and/or recognition methods. For example, the semantic annotation of the objects can be achieved using algorithms for pixel-level 2D semantic segmentation (e.g., deep neural networks). Each of the semantic objects includes one or more semantic annotations and descriptors, such as categorical labels, appearance descriptors, shape descriptors, size attributes, material attributes, 3D position and orientation, etc. For example, the semantic object representing the chair 120 captured on an image of a portion of the environment 100 may include the following semantic annotations and descriptors:

TABLE 1
Semantic Annotation and Descriptors for a Chair Object

| | |
|---|---|
| Object ID | 001 |
| Object Type | Chair |
| Group ID | Living room |
| Type | Static |
| Affordance | Movable |
| Functionality | Sitting |
| Attributes | Wood, upholstered, multiple legs |
| Appearance | Heavy, medium size |
| Position on image | (8, 2.5, 0), distribution N (0.2, 0.2, 0.2) |
| 3D bounding box | (0.8, 0.8, 0.5), orientation (0, 0, 0) |

In some embodiments, a mobile robot 102 (e.g., an autonomous or semi-autonomous cleaning device, delivery device, transportation device, surveillance device, etc.) navigates in the environment (e.g., on the floor 128 in the environment 100) to perform preprogrammed tasks (e.g., vacuuming/mopping the floor, performing security checks, delivering food items or medication, and/or traveling to a charging station or user-selected destination, etc.). In some embodiments, the mobile robot has onboard processing capability to process images, and uses the object semantic information to self-localize in the environment. In some embodiments, the mobile robot includes communication equipment to communication with a host device (e.g., a control station, a home station, a remote server, etc.) to transmit image data to and receive localization results from the host device. In some embodiments, the mobile robot 102 is equipped with both a front view camera (e.g., forward facing) and a top view camera (upward facing) to capture images at different perspectives in the environment 100. In some embodiments, the mobile robot 102 is further equipped with rear view camera, and/or downward view camera to capture images from different perspectives in the environment 100. In some embodiments, the mobile robot 102 sends the captured images to an onboard computer (e.g., or a remote computer via wireless connection) to extract object semantic information for localization purpose (e.g., computing the robot or the robot's camera's pose in the environment 100). In some embodiments, the mobile robot retrieves information needed for localization from a host device, as needed. In some embodiments, some or all of the steps described with respect to the mobile robot can be performed by a host device in communication with the mobile robot. The localization process based on object semantic information will be discussed in more detail below.

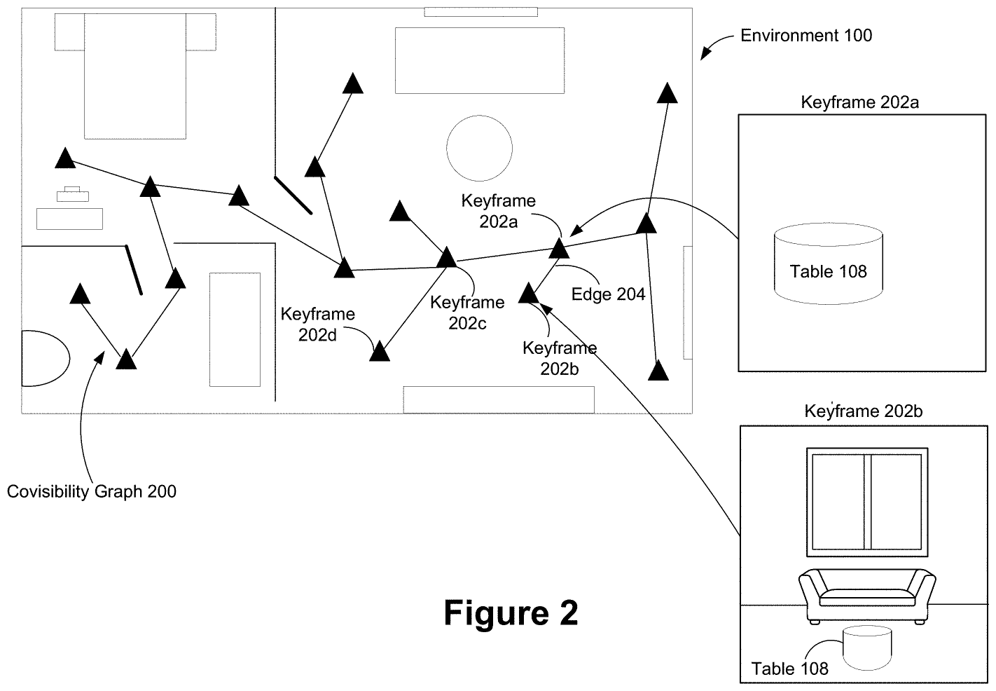

FIG. 2 is a schematic diagram of a co-visibility graph 200 created in accordance with images captured from the vantage points of a mobile robot navigating in the environment 100 (e.g., by the on-board cameras of the mobile robot) in accordance with some embodiments.

In some embodiments, the mobile robot 102 estimates a map of the environment 100 using only selected frames (also known as “keyframes”) that are significant for the features contained therein instead of indiscriminately using continuously captures frames (e.g., images from even intervals of a video of the environment). In this keyframe-based approach, the mobile robot 102 travels through the environment 100 and builds a co-visibility graph by capturing images (e.g., keyframes) of different portions of environment 100 and connecting the keyframes based on pre-established criteria. The keyframes are stored within the system and contain informational cues for localization. For example, a keyframe may store information of transform point from world coordinates to camera coordinates, the camera's intrinsic parameters (e.g., focal lengths and principal points), and all the features (points, lines or planes) in the camera images, in some embodiments. FIG. 2 shows the co-visibility graph 200 superimposed on a layout of the environment 100. The co-visibility graph 200 includes a plurality of nodes (e.g., represented by the black triangles in FIG. 2) corresponding to keyframes (e.g., keyframes 202a-202d, etc.). The respective location of a node in the environment 100 indicates the location at which the keyframe corresponding to the node was captured. An edge connecting two keyframes (e.g., edge 204 connecting keyframes 202a and 202b (or the corresponding nodes of the keyframes 202a and 202b in FIG. 2)) indicates that the two keyframes share at least a threshold number of map points in the environment 100. A map point is a point in the 3D space that is associated with a plurality of keyframes (e.g., captured in a plurality of keyframes, correspond to the same object captured in a plurality of keyframes, etc.). For example, a map point stores information such as a 3D position in world coordinate system, a viewing direction, descriptors, max and min distances where observed, etc. For example, the keyframe 202a is connected to the keyframe 202b by the edge 204 because these two keyframes share certain map points (e.g., map points that correspond to the table 108 that are captured in both keyframes 202a and 202b). In another example, keyframe 202a and keyframe 202d are not directly connected by an edge, indicating that the overlap of the two keyframes is low (e.g., they are captured at locations in the environment 100 that are too far away, or pointing at different portions of the environment, etc.). A co-visibility graph is a graph consisting of keyframes as nodes and edges between keyframes indicating that which pairs of keyframes have at least a threshold number of common map points between them (e.g., are more likely to capture the same portion of the environment, or capture the same objects corresponding to a respective functionality, etc.). In some embodiments, each object (e.g., the table 108) is associated with multiple map points on a keyframe. As shown in FIG. 2, the same object may appear with different sizes and positions in different keyframes and has different surrounding objects in different keyframes (e.g., table 108 in keyframes 202a and 202b), but at least a significant number of the map points corresponding to the table 108 can be recognized from both keyframes and linking the keyframes to one another in the co-visibility graph, in accordance with some embodiments.

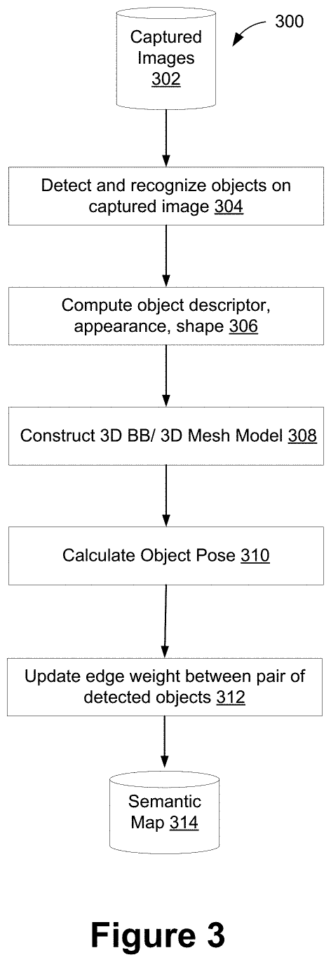

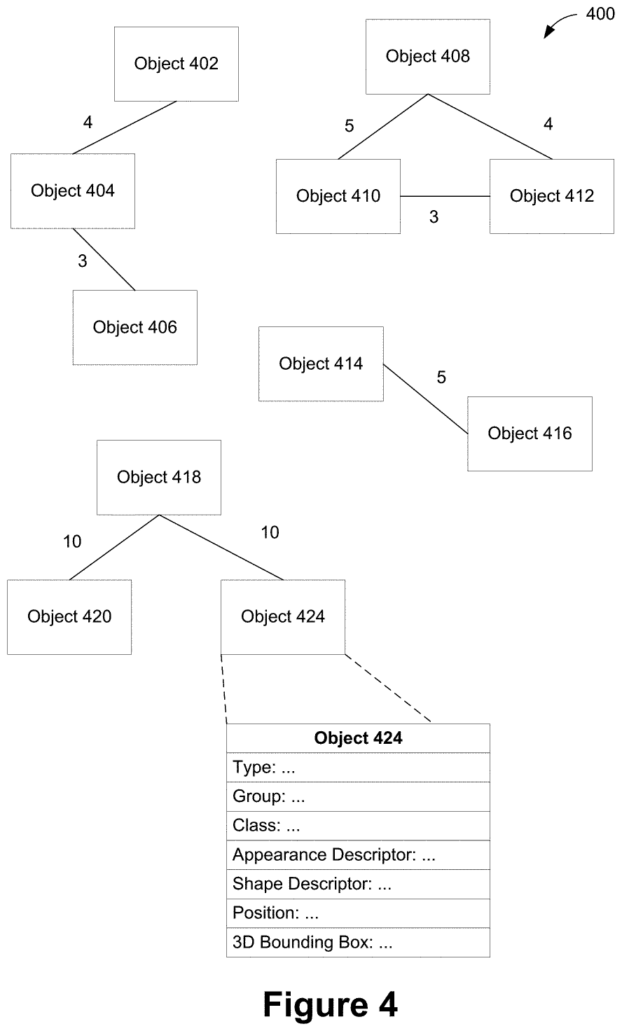

FIG. 3 is a flow diagram illustrating an exemplary process 300 of building a semantic map (different from the co-visibility graph) of an environment using camera data (e.g., image and camera pose data) in accordance with some embodiments. For convenience, the process 300 is described below as being implemented by a computer system, such as a computer onboard mobile robot 102. The semantic map includes detected objects from keyframes (e.g., as opposed to including raw map points, or keyframes) as nodes, and an edge between a pair of nodes in the semantic map indicates that the pair of objects have been captured together on at least one common keyframe. The edge weight of the edge between the pair of nodes in the semantic map is increased as the pair of nodes are identified together in each additional keyframe of the environment. A large edge weight indicates that the pair of objects have been captured together many times on the same keyframes. For examples of semantic maps or parts of the semantic map, refer to FIG. 4 and the related description. Note that the semantic map is different from the co-visibility map described in FIG. 2: the nodes of the co-visibility map correspond to keyframes and locations (and camera poses) from which the keyframes are captured, but the nodes of the semantic map correspond to semantic representation of objects that are identified from the keyframes. An edge between a pair of nodes in the co-visibility map indicates that the two connected nodes share at least a threshold number of map points (e.g., the two keyframes overlap to a certain degree, captures overlapping portions of the environment or capturing the same object(s), etc.), but an edge between a pair of nodes in the semantic map indicates that the respective semantic representations of objects corresponding to the two nodes have been captured together on certain keyframes. The meaning of co-visibility of map points on multiple keyframes and co-visibility of semantic objects in the same keyframe will be exploited to build a joint semantic and feature localization map.

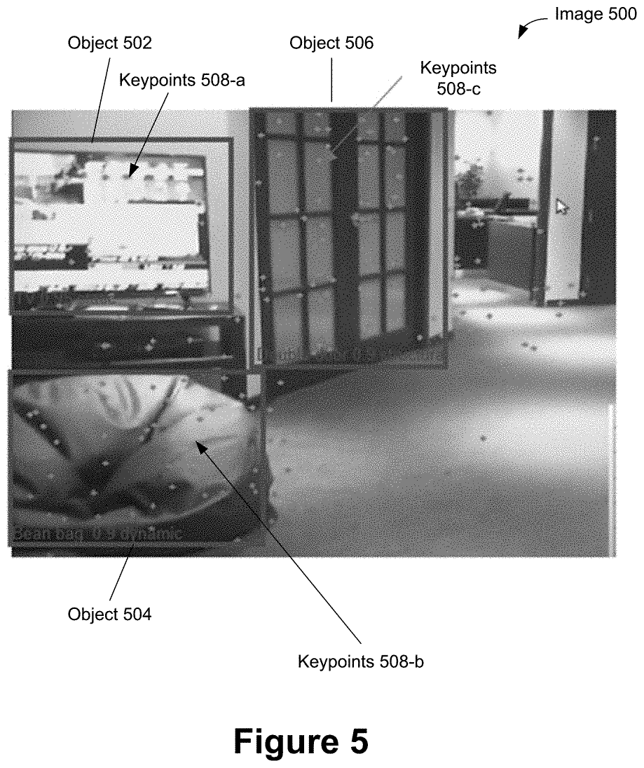

After the mobile robot 102 captures keyframes (e.g., captured images 302) in the environment and the computer system builds a co-visibility graph with the keyframes, the computer system detects and recognizes semantic information of objects on the captured images (Step 304 in FIG. 3) using an object classifier (e.g., a Recurrent Neural Network (RNN), or other similar classifiers, etc.), in accordance with some embodiments. On each of the identified objects recognized from the captured images, the computer system computes corresponding semantic information, including computing object description, appearance, shape descriptor, constructing 3D bounding box and/or 3D mesh models, and/or calculate 3D object pose (e.g., orientation, position, etc.) (Steps 306, 308, and 310 in FIG. 3). The semantic information is optionally stored for later use. In some embodiments, the computer system then consolidates the semantic information obtained from different images based on the objects that are identified from the images. For example, the computer system performs object re-identification to check if a detected object is already stored in the semantic map. The computer system first checks objects that are already registered from a previous keyframe—if the object that is detected in the current keyframe has a same category label as the object that is detected in the previous keyframe (e.g., both keyframes show the object as a “chair”) and the bounding boxes surrounding the two detected objects of the two keyframes are within a threshold distance of each other in the environment (the bounding box indicates regions of the keyframe where an object is located and have corresponding locations in the environment, see FIG. 5 for an example of a bounding box), the computer system associates the two detected objects with the same object ID (e.g., the computer system considers the two detected objects to be the same object in the environment). If the computer system is not able to re-identify the detected object from a previous keyframe, the computer system then searches for detected objects with the same category label in the semantic map that can be seen from the field of view (FOV) of the current frame. Once candidate object IDs are found from the search, the computer system compares the degree of similarity between the object of the current keyframe and the one in the semantic map (e.g., one of the candidate objects identified from the search) by computing the joint distance of appearance and shape descriptor by the formula below:

d=λ_{A}∥Aₒ^{kf}−Aₒ^{m}∥+λ_{S}∥Sₒ^{kf}−Sₒ^{m}∥,

where Aₒ^{kf} and Sₒ^{kf} represent appearance and shape descriptor of the associated objects in current keyframe respectively, Aₒ^{m} and Sₒ^{m} are appearance and shape descriptor of the associated objects in semantic map.

If the similarity distance d is above a preset threshold distance, the object in the current keyframe will be added in a to-be-verified objects pool and a new object ID will be assigned to the object, optionally, upon verification. In some embodiments, if there are no candidate objects identified in the semantic map from the search, the object in the current keyframe will be added to the to-be-verified objects pool as well, and a new object ID will be assigned to the object, optionally, upon verification. In some embodiments, the verification process includes the following determination: if the object in the to-be-verified objects pool is re-identified more than n (e.g., n>3) times, it will be added to the semantic map as a new object with its own object ID; and if the object in the to-be-verified objects pool is not re-identified more than m (m>10) times, it will be removed from to-be-verified objects pool. In some embodiments, parameters m and n can be chosen according to the object detection accuracy performance. In some embodiments, e.g., as shown in these examples, the setting is to provide favor to new object registration. If some objects are falsely detected, more stringent checking condition can be used to rule them out (m is chosen to be a larger number, as compared to n).

In some embodiments, as shown in Step 312 in FIG. 3, when two objects are found together in the same keyframe, the weight of the edge between two objects in the semantic map is updated (e.g., increased). For example, the weight can be defined as number of times that the two objects have been observed together on a same keyframe or a score that is positively correlated to the number of times that the two objects have been observed together on the same keyframe.

As shown in FIG. 3, the sematic map 314 of objects and their relationships in the environment is built once a sufficient number of keyframes of the environment are processed in the manner described above. The process of building a semantic map described above can be utilized to build a global semantic map of the environment, as well as building a local semantic map for a portion of the environment in which the mobile robot is currently navigating (e.g., for localization purpose).

FIG. 4 illustrates an exemplary semantic map 400 including multiple semantic graphs that correspond to different portions of an environment in accordance with some embodiments. For example, the semantic map 400 is built by the process 300 as described in FIG. 3 and accompanying descriptions. The semantic map 400 includes four separate semantic graphs, each having nodes representing unique object IDs (e.g., each graph includes a respective set of connected nodes (unique object IDs)). For example, the semantic graphs being separated (e.g., not connected by any edges) in a semantic map may be due to the fact that the semantic map was built from images captured by the mobile robot 102 while the mobile robot was located different rooms separated by walls and other structural barriers (e.g., each semantic graph would represent a different room that cannot be seen from another room). For example, in FIG. 4, semantic graph 1 includes three objects 402, 404, and 406. The edge between objects 402 and 406 has a weight of 4, optionally indicating that the objects 402 and 406 are co-present on four (or a multiple of four, or a score of four based on some other scoring metric measuring the frequency of co-presence) of the processed keyframes for this semantic map. Similarly, the edge between objects 404 and 406 has a weight of 3, optionally indicating that the objects 404 and 406 are co-present on three (or a multiple of four, or a score of three based on some other scoring metric measuring the frequency of co-presence) keyframes. The nodes in the semantic graph 1 are not connected to other nodes in the semantic map, indicating that there are not sufficient instances of co-presence (e.g., less than one, less than a threshold number, less than a threshold score, etc.) between the nodes in the semantic graph 1 (e.g., nodes 402, 404, and 406) and other nodes found in the semantic map. The three other semantic graphs respective include objects 408, 410, and 412, objects 414 and 416, objects 418, 420, and 424, and the respective sets of edges connecting the nodes in each graph. In some embodiments, as shown in FIG. 4, the semantic map includes semantic information for each object. For example, metadata for object 424 includes semantic information such as the type of the object, the group of the object, the class of the object, appearance descriptor of the object, shape descriptor of the object, position information of the object, and 3D bounding box information of the object, etc. Refer to Table 1 for an example of a list of semantic information for an object. In some embodiments, the exemplary semantic map 400 is representative of a global semantic map for the whole environment. In some embodiments, the exemplary semantic map 400 or a semantic map including fewer sematic graphs (e.g., one or two semantic graphs) is representative of a local semantic map for a portion of the environment in which the mobile robot is currently navigating.

FIG. 5 illustrates an exemplary image 500 (e.g., a keyframe) including both identified semantic objects (e.g., objects 502-506 enclosed in respective bounding boxes) and features (a first plurality of keypoints 508-a, a second plurality of keypoints 508-b, a third plurality of keypoints 508-c, and other keypoints, respectively corresponding to selected map points of a stored keyframe) in accordance with some embodiments. The bounding boxes around each object estimate the size and location of the objects on the image 500.

As set for earlier, existing Visual SLAM system relies exclusively on map points (e.g., selected 3D points of the environment) to recursively track each keyframe and to localize a robot's 3D pose (e.g., based on camera pose). With the semantic map described in FIGS. 3-4, a method to jointly combine a semantic map (e.g., the semantic map 400) and a feature localization map (e.g., maps including keypoints and/or lines) can be used for more efficient localization.

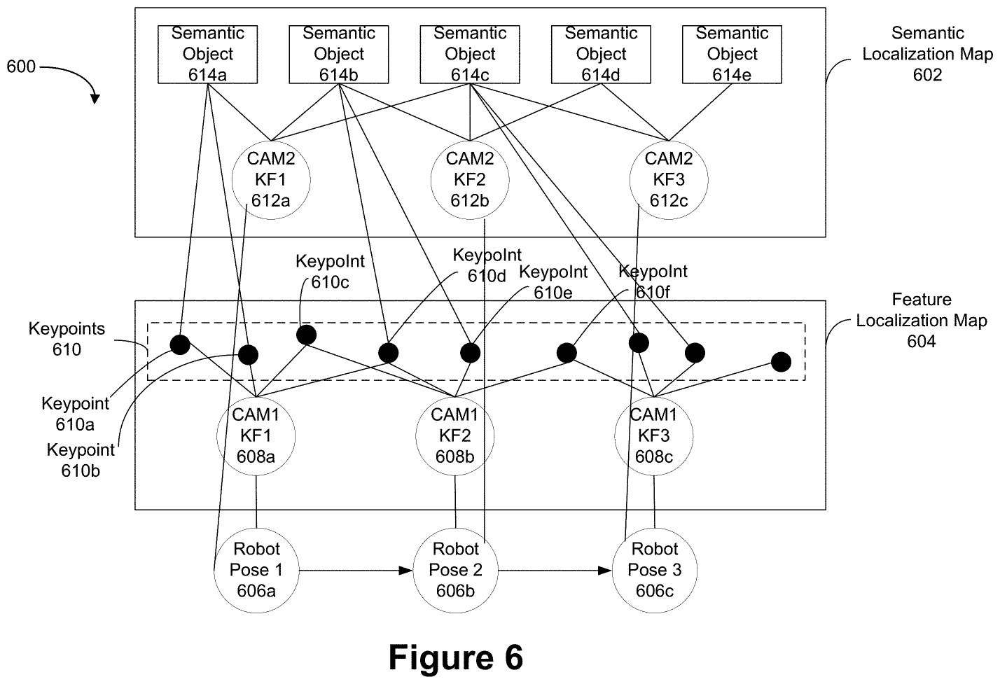

FIG. 6 illustrates an exemplary joint semantic and feature localization map 600 in accordance with some embodiments. The joint semantic and feature localization map 600 includes a semantic localization map 602 (also known as a semantic map, such as the semantic map 400 in FIG. 4), and a feature localization map 604. As described in FIG. 5, the feature localization map includes keypoints (or lines) of the images, which can be mapped to map points of the environment for localization. The semantic localization map 602 and the feature localization map 604 are joined by mapping features from the feature localization map 604 to corresponding semantic objects in the semantic localization map 602.

In the example shown in FIG. 6, the semantic localization map 602 includes five different semantic objects (e.g., semantic objects 614a-614e), which have been extracted from three keyframes (CAM2 KF1 612a, CAM2 KF2 612b, CAM2 KF3 612c) captured by a second camera of the mobile robot 102. For example, the semantic objects 614a-614c are captured on the first keyframe (CAM2 KF1 612a), the semantic objects 614b-614d are captured on the second keyframe (CAM2 KF2 612b), and the semantic objects 614c-614e are captured on the third keyframe (CAM2 KF2 612c), as represented by the respective sets of edges connecting the semantic objects and the keyframes in the semantic localization map 602.

The feature localization map 604 includes multiple keypoints (e.g., keypoints 610a-610f and others) on different keyframes captured by a first camera. In some embodiments, the first camera and the second camera are the same camera; and in some embodiments, they are different cameras. The feature localization map 604 shows, for example, that the keypoints 610a-610d are present on a first keyframe (CAM1 KF1 608a), the keypoints 610c-610f are present on a second keyframe (CAM1 KF2 608b), etc.

In some embodiments, the corresponding keyframes in the semantic localization map 602 and the feature localization map 604 are captured with the same robot/camera pose. For example, CAM2 KF1 612a and CAM1 KF1 608a are both captured with the robot pose 1 606a, CAM2 KF2 612b and CAM1 KF2 608b are both captured with the robot pose 2 606b, and CAM2 KF3 612c and CAM1 KF2 608b are both captured with the robot pose 2 606b.

The joint semantic and localization map 600 connects the semantic localization map 602 with the feature localization map 604 by mapping corresponding feature (keypoints or lines) in a keyframe in the feature localization map to corresponding semantic objects in a keyframe in the semantic localization map. For example, keypoints 610a-610d are determined to be correspond to the semantic object 614a in accordance with a determination that these keypoints are within the bounding box of the object 614a on CAM2 KF1 612. For example, this is illustrated in FIG. 5, where the keypoints 508-c in FIG. 5 correspond to the object 506, as those keypoints are within the bounding box surrounding the object 506).

In some embodiments, the SLAM process is used to compute keypoints of a keyframe and maps the keypoints to corresponding map points of the environment (e.g., ORB-SLAM). The objects detected from both top and front cameras of the mobile robot 102 are processed and registered into the semantic localization map. To build a joint semantic and feature localization map, if an object can be detected in one keyframe, an edge between the object and the keyframe will be added (e.g., the semantic object 614a is connected with CAM2 KF1 612a). If a feature of the feature localization map can be mapped onto an object bounding box or pixel segmentation mask for a semantic object in the semantic localization map, an edge between the feature and the semantic object will be added (e.g., keypoint 610a is connected with the semantic object 614a in FIG. 6). In FIG. 6, multiple keypoints (e.g., keypoints 610a and 610b in keyframe 608a) were mapped to semantic object 614a; multiple keypoints (e.g., keypoints 610d and 610e in keyframe 608b) were mapped to sematic object 614b, etc. At this point, the topological semantic graphs in the semantic map are associated with keypoints (and corresponding map points in the environment) in stored keyframe, where collections of keypoints (and corresponding map points) are further associated with known camera poses (e.g., keypoints 610a-610d in stored keyframe 608a are associated with pose 1 606a, keypoints 610c-610f in stored keyframe 608b are associated with pose 2 606b).

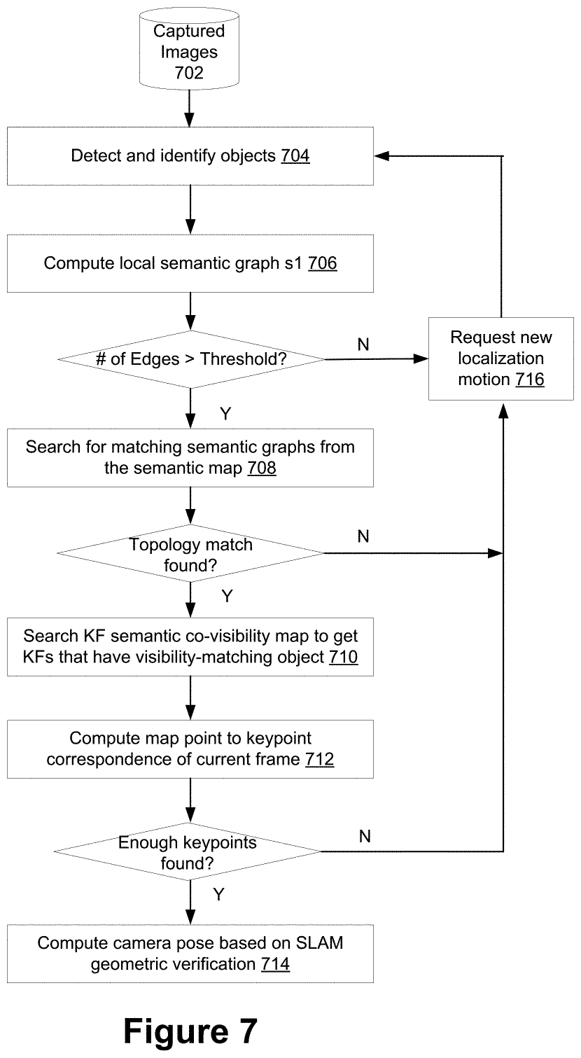

FIG. 7 is a flow diagram illustrating an exemplary process 700 of localizing a mobile robot in an environment using a joint semantic and feature localization map in accordance with some embodiments. For convenience of description, the process is described as being implemented by a computer system, such as an onboard computer of the mobile robot 102, in accordance with some embodiments.

The system first receives captured images 702 (e.g., keyframes) and detect and identify objects (704) on the keyframes. The system next uses the object semantic information to compute a local semantic graph S₁ (706) that represents a portion of the environment captured on the respective keyframe. An example of a semantic graph can be seen in FIG. 4 (one of the disconnected graphs). The process of building the local semantic graph S₁ is similar to the process of building a semantic map as described in FIG. 3, the difference being that the local semantic graph S₁ is built based on captured images of a portion of the environment, but the global semantic map is built based on captured images of the entire environment.

If the local semantic graph has enough edges (e.g., more than 3 edges, more than a preset threshold number of edges other than three, etc.), the computer system searches for matching semantic graphs from a previously constructed semantic map (e.g., the global semantic map 400 in FIG. 4, constructed according to the process 300 in FIG. 3) (708). If one or more matched topologies (e.g., individual semantic graphs of the global semantic map that have sufficient similarity to the local semantic graph in terms of nodes and edges) are found, the system extracts the corresponding keyframes from joint semantic and localization map that have co-visibility of matched object IDs in the matched semantic graphs (710). The computer system then computes map point to keypoint correspondence of the current frame (712). The current frame is the image that is captured by the mobile robot at its current location and pose. The keypoints in the current frame are mapped to map points of the environment that is in the matched keyframes and the camera position and pose information associated with the matched keyframes are used as the basis to determine the current location and camera pose of the mobile robot. For example, the computer system uses a graph optimization based approach (e.g. relocalization calculation in ORB SLAM) to compute the robot/camera position and pose (714).

In an example, referring to FIG. 6, if the local semantic graph s1 includes the semantic object 614a, 614b, and 614c, then the corresponding keyframes that have co-visibility of the matched object IDs are CAM2 KF1 612a and CAM1 KF1 608a (CAM1 KF1 608a and CAM2 KF2 612a are captured at the same robot pose 1 606a. The corresponding keypoints that are associated with semantic objects in the matched keyframe are keypoints 610a, 610b and 610d (which are associated with CAM1 KF1 608a). The system will then compute the correspondence between keypoints in the current frame and the keypoints 610a, 610b, and 610c, and if sufficient correspondence is found (e.g., more than a threshold number of keypoints are matched between the current frame and the matched keyframe), then the current camera position and pose can be deduced based on the map points corresponding to the keypoints of the current frame.

In some embodiments, if the local semantic graph s1 does not have enough edges, or if there is no matched topology from the semantic localization map, or if there do not exist enough keypoints on the current frame that correspond to the keypoints of a matched keyframe of the environment, the computer system requests new localization motion (716) and capture a new set of keyframes for the current portion of the environment (and subsequently identifies a new matched keyframe with known camera position and pose information).

To search for matching semantic graphs from the global semantic localization map (708), the computer system is configured to:
1. For each vertex object {oᵢ}, find matched candidate object ID from the semantic map Sₘ;
2. Extract edges from the semantic map Sₘ which have both nodes belonging to {mᵢ} and construct semantic sub-map S′ₘ, where {mᵢ} are all covisibilty edges in the semantic map Sₘ;
3. Mark all matched edge of S₁ in S′ₘ and remove the unmatched edges in S′ₘ;
4. Find all connected graphs {gⱼ} in S′ₘ and compute size of each connected graph {gⱼ};
5. If |gᵢ|>3, include the connected graph gⱼ as a relocalization candidate.

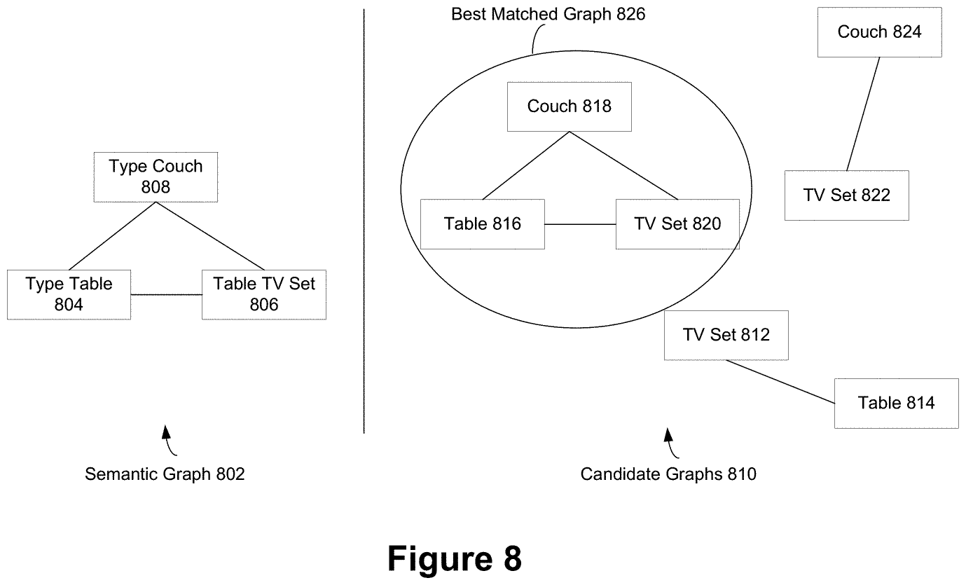

FIG. 8 illustrates an exemplary topology graph matching scheme for localizing a mobile robot in an environment (e.g., the method outlined above) in accordance with some embodiments. For example, the topology graph matching scheme is performed in response to reaching the step 708 of FIG. 7, which searches for a matching semantic graph from a global semantic map. The semantic graph 802 on the left of FIG. 8 is a topological graph with three object types (e.g., couch, table, and TV set). The semantic graph 802 is constructed based on a plurality of images that are captured in a local portion of the global environment or based on a current frame (e.g., in accordance with the method described with respect to FIG. 3). The candidate semantic graphs 810 are semantic graphs from a semantic map with at least one matching objects ID as the semantic graph 802. The best matched graph 826 is the graph among the candidate graphs 810 that most closely matches the topology of the semantic graph 802 (e.g., having the most number of matching object IDs, and having the correct edges connecting the objects). FIG. 8 illustrates an exemplary topology graph matching scheme for localizing a mobile robot in an environment in accordance with some embodiments.

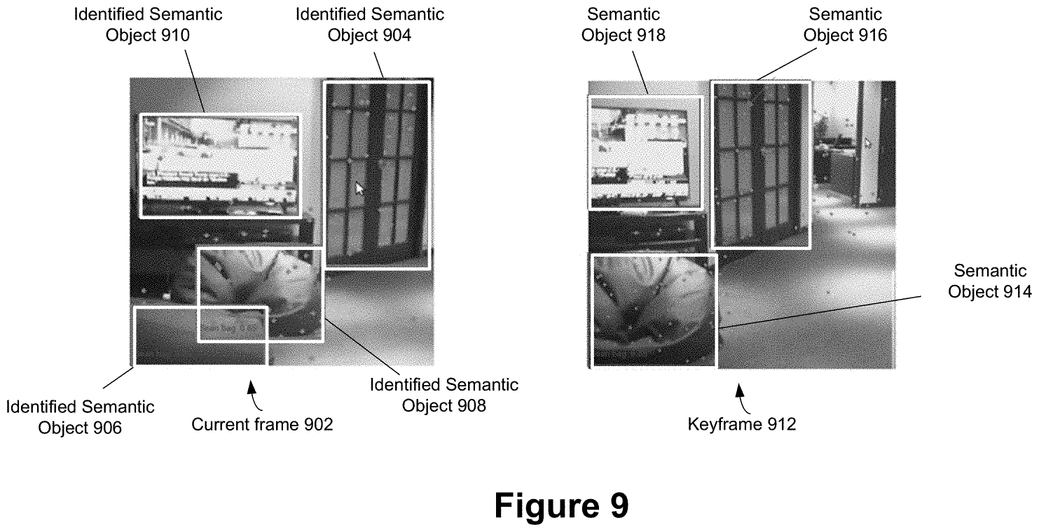

FIG. 9 illustrates an exemplary comparison of a current frame of captured images and a corresponding keyframe that has been identified from a keyframe database using the process described in FIG. 7 for localizing a mobile robot in an environment in accordance with some embodiments.

The mobile robot 102 first captures an image (e.g., current frame 902) of a portion of the environment 100, and processes the image to identify semantic information (e.g., in accordance with step 304 to step 406 of FIG. 3). The current frame 902 includes 4 objects (e.g., identified semantic object 904, 906, 908, and 910). The computer system then constructs a local semantic graph from the current frame 902, and searches a global semantic map (e.g., a database with keyframes with associated semantic information) to identify the closely matching keyframe to the current image (e.g., in accordance with the step 708 through step 710 in the process 700). In FIG. 9, keyframe 912 has the closest visibility-matching objects of the semantic map database. After the matching keyframe 912 is identified, the keypoints on the current frame (e.g., the respective sets of dots inside the bounding boxes of the identified semantic objects 910, 904, and 908) and the keypoints on the matched keyframe 912 (e.g., the respective sets of dots inside the bounding boxes of the identified semantic objects 918, 916, and 914) are compared to determine if there are sufficient level of correspondence between the keypoints in the current frame and the keypoints in the matched keyframe. If sufficient level of correspondence is found, the camera position and pose of the current frame is computed based on the known camera position and pose of the matched keyframe and, optionally, based on the correspondence between the keypoints in the current frame 902 and the keypoints in the matched keyframe 912.

In some embodiments, the topological semantic map that is built for the environment or portions thereof can also be used for room classification, and operation strategy determination (e.g., cleaning strategy determination based on current room type, etc.).

In some embodiments, the process of room segmentation includes the following steps:
1. Disconnect all edges that associate with structural objects;
2. Search the global sematic graph and get all connected sub-graphs under a predefined radius (e.g., a typical maximum room size);
3. For each sub graphs, construct bag of words based on semantic object label distribution;
4. Use a trained fully convolutional network (FCN) or Support Vector Machine (SVM) model to classify the room type.

In some embodiments, during the training phase, the following procedure can be performed:
1. Collect all sample images of the environment, and label room type of each sample image;
2. Detect semantic object using a trained Convolutional Neural Network (CNN) model from the sample images;
3. Construct the bag of words based on semantic labels of the sample images; and
4. Train an FCN network or a SVM for inference of room type.

Table 2 below shows an example room type inference model with different weights associated with different semantic objects in the image.

TABLE 2
Room type inference model

| | Kitchen | Living room | Bedroom | . . . |
|---|---|---|---|---|
| Dining table | Wₖ₁ | Wₗ₁ | W_{B1} | . . . |
| Chair | Wₖ₂ | Wₗ₂ | W_{B2} | . . . |
| Sofa | Wₖ₃ | Wₗ₃ | W_{B3} | . . . |
| TV | Wₖ₄ | Wₗ₄ | W_{B4} | . . . |
| Sink | Wₖ₅ | Wₗ₅ | W_{B5} | . . . |
| Stove | Wₖ₆ | Wₗ₆ | W_{B6} | . . . |
| Bathtub | Wₖ₇ | Wₗ₇ | W_{B7} | . . . |
| . . . | . . . | . . . | . . . | . . . |

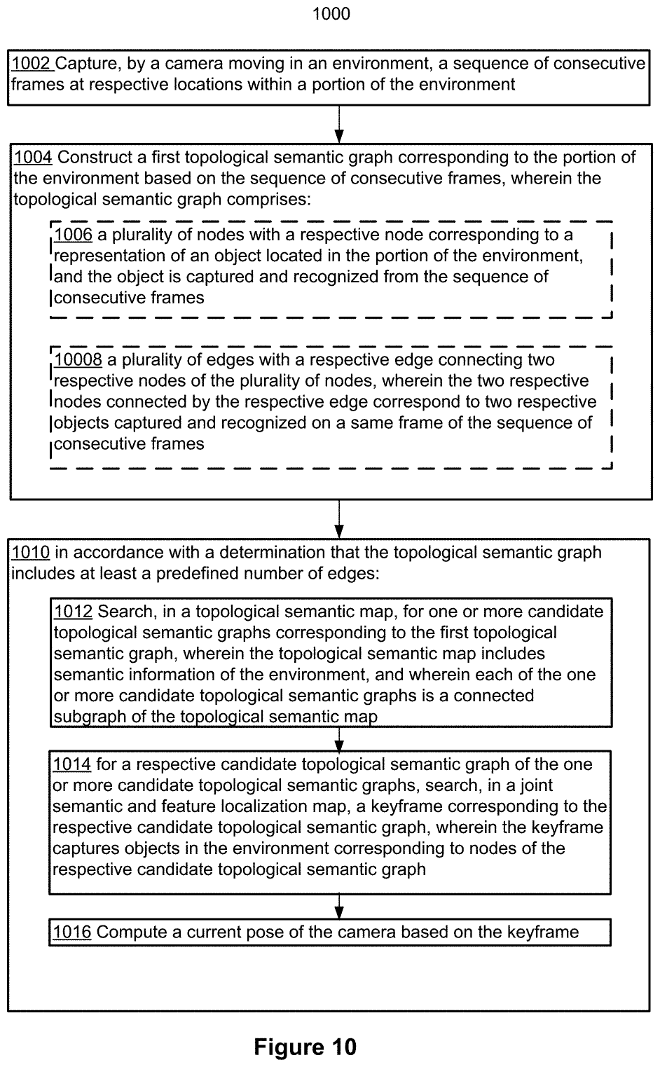

FIG. 10 illustrates an exemplary flowchart for a process 1000 of localizing a mobile robot in an environment in accordance with some embodiments. The process 1000 is optionally performed by the onboard processing units of the mobile robot, in accordance with some embodiments. In some embodiments, the process 1000 is performed by a server in communication with the mobile robot. In some embodiments, the process 1000 is performed jointly by the mobile robot and a server in communication with the mobile robot over a network. For ease of description, the steps of the process 1000 are described with respect to a mobile robot, which is non-limiting and may be understood to be performed by the server or jointly by the mobile robot and the server, in accordance with various embodiments.

As the first step, the mobile robot captures (1002), by a camera, a sequence of consecutive frames at respective locations within a portion of the environment.

The mobile robot then constructs (1004) a first topological semantic graph (e.g., a local semantic graph S₁) corresponding to the portion of the environment based on the sequence of consecutive frames. In some embodiments, the topological semantic graph comprises: a plurality of nodes (1006) with a respective node corresponding to a representation of an object (e.g., object ID and semantic information of the object) located in the portion of the environment, and the object is captured and recognized from the sequence of consecutive frames (e.g., the objects are recognized using object detection and recognition algorithms such as RCNN), and a plurality of edges (1008) with a respective edge connecting two respective nodes of the plurality of nodes, wherein the two respective nodes connected by the respective edge correspond to two respective objects captured and recognized on a same frame of the sequence of consecutive frames (e.g., if the representation of the two objects are connected in the topological semantic graph, then they exist at least together on one frame. In some embodiments, if the two objects exist on more than one frame, a weight of the edge connecting the two nodes corresponding to the two objects is increased proportionally to the number of frames that capture both of the objects.).

In accordance with a determination that the topological semantic graph includes at least a predefined number of edges (e.g., at least three edges) (1010): the mobile robot searches (1012), in a topological semantic map (e.g., semantic map/semantic map database Sₘ), for one or more candidate topological semantic graphs (e.g., {gⱼ}) corresponding to the first topological semantic graph (e.g., a candidate topological semantic graph has at least a predefined number of nodes (e.g., 3) that are also included in the topological semantic map), wherein the topological semantic map includes semantic information of the environment (e.g., the topological semantic map is previously constructed and includes at least semantic information of the portion of the environment), and wherein each of the one or more candidate topological semantic graphs is a connected subgraph of the topological semantic map.

For a respective candidate topological semantic graph of the one or more candidate topological semantic graphs, the mobile robot searches (1014), in a joint semantic and feature localization map (e.g., the joint semantic and localization map of FIG. 8), a keyframe corresponding to the respective candidate topological semantic graph, wherein the keyframe captures objects in the environment corresponding to nodes of the respective candidate topological semantic graph (e.g., the keyframe has co-visibility with matched object IDs).

The mobile robot computes (1016) the current pose of the camera based on the keyframe. In some embodiments, the mobile robot computes the current pose of the camera by comparing a plurality of keypoints on the sequence of consecutive frames to a plurality of three-dimensional map points of the environment (e.g., the three-dimensional map points are within bounding boxes (e.g., imposed by the object detection and recognition algorithm) of the recognized objects). In some embodiments, a PnP algorithm followed by graph optimization approach such as relocalization calculation in ORB SLAM can be used to compute the camera pose.

In some embodiments, the topological semantic map is a previously-constructed graph comprising: a plurality of nodes with a respective node corresponding to a representation of an object recognized from previously-captured frames in the environment (e.g., of the entire environment or a substantive portion of the environment), and a plurality of edges with a respective edge connecting two respective nodes of the plurality of nodes, wherein the two respective nodes connected by a respective edge correspond to two respective objects recognized from a same frame of the previously-captured frames in the entire environment.

In some embodiments, the joint semantic and feature localization map comprises: a semantic localization map (e.g., see the semantic localization map of FIG. 8) that maps a plurality of representations of the objects in the environment to a plurality of keyframes captured in the environment; and a keypoint localization map that maps a plurality of three-dimensional map points in the environment to the plurality of keyframes captured in the environment.

In some embodiments, searching, in the topological semantic map, for the one or more candidate topological semantic graphs corresponding to the first topological semantic graph includes: for a respective node of the first topological semantic graph, identifying one or more nodes in the topological semantic map that share a same object identifier with that of the respective node of the first topological semantic graph; locating edges in the topological semantic map that connect any two of the identified one or more nodes in the topological semantic map; building a subset of the topological semantic map by maintaining the identified one or more nodes and the identified one or more edges, and removing other nodes and edges of the topological semantic map; identifying one or more connected topological semantic graphs in the subset of the topological semantic map; and in accordance with a determination that a respective connected topological semantic graph in the subset of the topological semantic map has at least a predefined number of nodes, including the respective connected topological semantic graph in the one or more candidate topological semantic graphs.

In some embodiments, the respective edge of the plurality of edges connecting the two respective nodes of the plurality of nodes is associated with an edge weight, and wherein the edge weight is proportional to a number of frames in the sequence of consecutive frames that capture both the two respective objects corresponding to the two respective nodes.

In some embodiments, comparing the plurality of keypoints on the sequence of consecutive frames to the plurality of three-dimensional map points of the environment includes comparing a subset of the plurality of keypoints that correspond to recognized objects (e.g., within detection and recognition bounding boxes of the recognized objects) to three-dimensional map points that correspond to the same objects (e.g., within detection and recognition bounding boxes of the recognized objects).

In some embodiments, comparing the plurality of keypoints on the sequence of consecutive frame to the plurality of three-dimensional map points of the environment includes performing a simultaneous localization and mapping (SLAM) geometric verification.

In some embodiments, the representation of the object includes an object ID specifying one or more characteristics of the object including: a portability type of the object (e.g., dynamic v. static), a location group of the object (e.g., in which room/area is the object located), a probabilistic class of the object (e.g., the nature of the object, e.g., a coffee table and its confidence level), an appearance descriptor of the object (e.g., color, texture, etc.), a shape descriptor of the object (e.g., square, round, triangle, etc.), a position and an orientation of the object in the respective frame, and a position of a three-dimensional bounding box that surrounds the object (e.g., and generated by a detection and recognition algorithm).

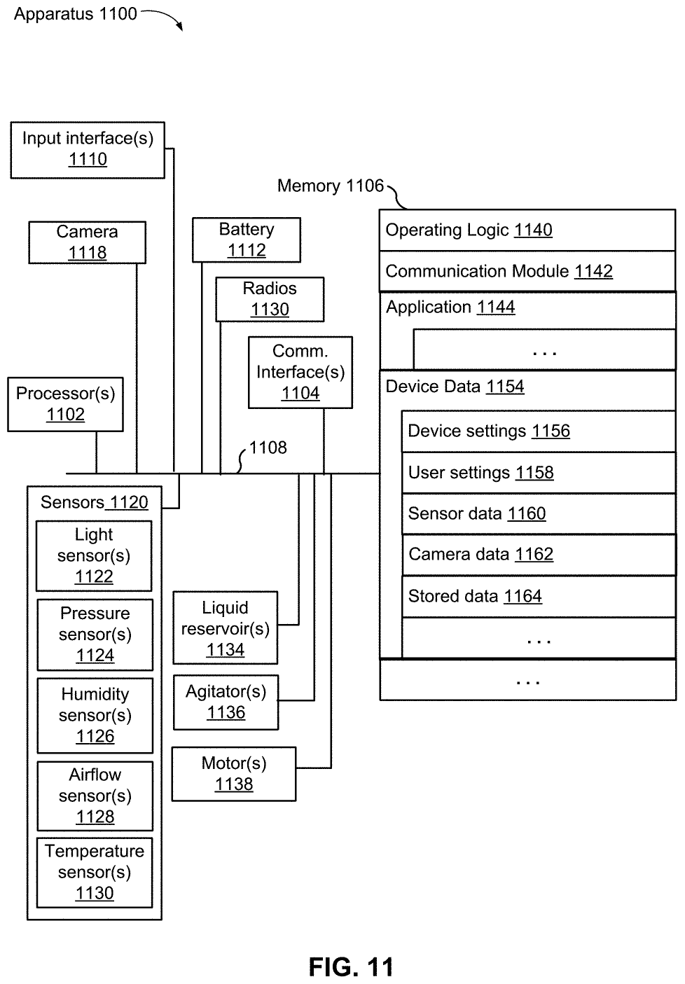

FIG. 11 illustrates a block diagram of an apparatus 1100 in accordance with some embodiments. The apparatus 1100 includes a mobile robot 102, in some embodiments. In some embodiments, the apparatus 1100 includes a server in communication with the mobile robot. The apparatus 1100 is a representative of an electronic device that performs the process 1000 in FIG. 10, in accordance with some embodiments.

The apparatus 1100 includes one or more processor(s) 1102, one or more communication interface(s) 1104 (e.g., network interface(s)), memory 1106, and one or more communication buses 1108 for interconnecting these components (sometimes called a chipset).

In some embodiments, the apparatus 1100 includes input interface(s) 1110 that facilitates user input.

In some embodiments, the apparatus 1100 includes one or more camera 1118. In some embodiments, the camera 1118 is configured to capture images in color. In some embodiments, the camera 1118 is configured to capture images in black and white. In some embodiments, the camera 1118 captures images with depth information.

In some embodiments, the apparatus 1100 includes a battery 1112. The apparatus 1100 also includes sensors 1120, such as light sensor(s) 1122, pressure sensor(s) 1124, humidity sensor(s) 1126, airflow sensor(s) 1128, and/or temperature sensor(s) 1130 to facilitate tasks and operations of the mobile robot (e.g., cleaning, delivery, etc.). In some embodiments, the apparatus 1100 also includes liquid reservoir(s) 1134, agitator(s) 1136, and/or motors 1138 to execute a cleaning task (e.g., sweeping, scrubbing, mopping, etc.).

In some embodiments, the apparatus 1100 includes radios 1130. The radios 1130 enable one or more communication networks, and allow the apparatus 1100 to communicate with other devices, such as a docking station, a remote control device, a server, etc. In some implementations, the radios 1130 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, Ultrawide Band (UWB), software defined radio (SDR) etc.) custom or standard wired protocols (e.g., Ethernet, HomePlug, etc.), and/or any other suitable communication protocol, including communication protocols not yet developed as of the filing date of this document.

The memory 1106 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 1106, optionally, includes one or more storage devices remotely located from one or more processor(s) 1102. The memory 1106, or alternatively the non-volatile memory within the memory 1106, includes a non-transitory computer-readable storage medium. In some implementations, the memory 1106, or the non-transitory computer-readable storage medium of the memory 1106, stores the following programs, modules, and data structures, or a subset or superset thereof:
operating logic 1140 including procedures for handling various basic system services and for performing hardware dependent tasks;
a communication module 1142 (e.g., a radio communication module) for connecting to and communicating with other network devices (e.g., a local network, such as a router that provides Internet connectivity, networked storage devices, network routing devices, server systems, and/or other connected devices etc.) coupled to one or more communication networks via the communication interface(s) 1104 (e.g., wired or wireless);
application 1144 for performing tasks and self-locating, and for controlling one or more components of the apparatus 1100 and/or other connected devices in accordance with preset instructions.
device data 1138 for the apparatus 1100, including but not limited to:
   device settings 1156 for the apparatus 1100, such as default options for performing tasks; and
   user settings 1158 for performing tasks;
   sensor data 1160 that are acquired (e.g., measured) from the sensors 1120;
   camera data 1162 that are acquired from the camera 1118; and
   stored data 1164. For example, in some embodiments, the stored data 1164 include the semantic and feature maps of the environment, camera pose and map points of stored keyframes, etc. in accordance with some embodiments.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 1106 stores a subset of the modules and data structures identified above. Furthermore, the memory 1106 may store additional modules or data structures not described above. In some embodiments, a subset of the programs, modules, and/or data stored in the memory 1106 are stored on and/or executed by a server system, and/or by a mobile robot. Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof

It will also be understood that, although the terms first, second, etc. are, in some instances, used herein to describe various elements, these elements should not be limited by these terms. These terms are only used to distinguish one element from another. For example, a first sensor could be termed a second sensor, and, similarly, a second sensor could be termed a first sensor, without departing from the scope of the various described implementations. The first sensor and the second sensor are both sensors, but they are not the same type of sensor.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated. The above clearly and completely describes the technical solutions in the embodiments of the present application with reference to the accompanying drawings in the embodiments of the present application. The described embodiments are merely a part rather than all of the embodiments of the present application. All other embodiments obtained by persons of ordinary skill in the art based on the embodiments of the present application without creative efforts shall fall within the protection scope of the present application.

What is claimed is:

1. A method, comprising:
capturing, by a camera moving in an environment, a sequence of consecutive frames at respective locations within a portion of the environment;
constructing a first topological semantic graph corresponding to the portion of the environment based on the sequence of consecutive frames; and
in accordance with a determination that the topological semantic graph includes at least a predefined number of edges:
searching, in a topological semantic map of the environment, one or more candidate topological semantic graphs corresponding to the first topological semantic graph;
for a respective candidate topological semantic graph of the one or more candidate topological semantic graphs, searching, in a joint semantic and feature localization map, for a keyframe corresponding to the respective candidate topological semantic graph, wherein the keyframe captures objects in the environment corresponding to nodes of the respective candidate topological semantic graph; and
computing a current pose of the camera based on the keyframe.

2. The method of claim 1, wherein the topological semantic graph includes:
a plurality of nodes with a respective node corresponding to a representation of an object located in the portion of the environment, wherein the object is captured and recognized from the sequence of consecutive frames; and
a plurality of edges with a respective edge connecting two respective nodes of the plurality of nodes, wherein the two respective nodes connected by the respective edge correspond to two respective objects captured and recognized on a same frame of the sequence of consecutive frames.

3. The method of claim 1, wherein the topological semantic map of the environment includes semantic information of the environment, and each of the one or more candidate topological semantic graphs is a connected subgraph of the topological semantic map.

4. The method of claim 1, wherein computing the current pose of the camera based on the keyframe includes comparing a plurality of keypoints on the sequence of consecutive frames to a plurality of three-dimensional map points of the environment corresponding to the keyframe; and determining the current pose of the camera based on a result of the comparing and known camera poses associated with the plurality of three-dimensional map points of the environment.

5. The method of claim 1, wherein the joint semantic and feature localization map comprises:
a semantic localization map that maps a plurality of representations of the objects in the environment to a plurality of keyframes captured in the environment; and
a feature localization map that maps a plurality of three-dimensional map points in the environment to the plurality of keyframes captured in the environment.

6. The method of claim 1, wherein searching, in the topological semantic map, for the one or more candidate topological semantic graphs corresponding to the first topological semantic graph includes:
for a respective node of the first topological semantic graph, identifying one or more nodes in the topological semantic map that share a same object identifier with that of the respective node of the first topological semantic graph;
locating edges in the topological semantic map that connect any two of the identified one or more nodes in the topological semantic map;
building a subset of the topological semantic map by maintaining the identified one or more nodes and the identified one or more edges, and removing other nodes and edges of the topological semantic map;
identifying one or more connected topological semantic graphs in the subset of the topological semantic map; and
in accordance with a determination that a respective connected topological semantic graph in the subset of the topological semantic map has at least a predefined number of nodes, including the respective connected topological semantic graph in the one or more candidate topological semantic graphs.

7. The method of claim 6, wherein comparing the plurality of keypoints on the sequence of consecutive frame to the plurality of three-dimensional map points of the environment includes performing a geometric verification, which is realized by PnP followed by graph based optimization.

8. An electronic device, comprising:
one or more processing units;
memory; and
a plurality of programs stored in the memory that, when executed by the one or more processing units, cause the one or more processing units to perform operations comprising:
capturing, by a camera moving in an environment, a sequence of consecutive frames at respective locations within a portion of the environment;
constructing a first topological semantic graph corresponding to the portion of the environment based on the sequence of consecutive frames; and
in accordance with a determination that the topological semantic graph includes at least a predefined number of edges:
searching, in a topological semantic map of the environment, one or more candidate topological semantic graphs corresponding to the first topological semantic graph;
for a respective candidate topological semantic graph of the one or more candidate topological semantic graphs, searching, in a joint semantic and feature localization map, for a keyframe corresponding to the respective candidate topological semantic graph, wherein the keyframe captures objects in the environment corresponding to nodes of the respective candidate topological semantic graph; and
computing a current pose of the camera based on the keyframe.

9. The electronic device of claim 8, wherein the topological semantic graph includes:
a plurality of nodes with a respective node corresponding to a representation of an object located in the portion of the environment, wherein the object is captured and recognized from the sequence of consecutive frames; and
a plurality of edges with a respective edge connecting two respective nodes of the plurality of nodes, wherein the two respective nodes connected by the respective edge correspond to two respective objects captured and recognized on a same frame of the sequence of consecutive frames.

10. The electronic device of claim 8, wherein the topological semantic map of the environment includes semantic information of the environment, and each of the one or more candidate topological semantic graphs is a connected subgraph of the topological semantic map.

11. The electronic device of claim 8, wherein computing the current pose of the camera based on the keyframe includes comparing a plurality of keypoints on the sequence of consecutive frames to a plurality of three-dimensional map points of the environment corresponding to the keyframe; and determining the current pose of the camera based on a result of the comparing and known camera poses associated with the plurality of three-dimensional map points of the environment.

12. The electronic device of claim 8, wherein the joint semantic and feature localization map comprises:
a semantic localization map that maps a plurality of representations of the objects in the environment to a plurality of keyframes captured in the environment; and
a feature localization map that maps a plurality of three-dimensional map points in the environment to the plurality of keyframes captured in the environment.

13. The electronic device of claim 8, wherein searching, in the topological semantic map, for the one or more candidate topological semantic graphs corresponding to the first topological semantic graph includes:
for a respective node of the first topological semantic graph, identifying one or more nodes in the topological semantic map that share a same object identifier with that of the respective node of the first topological semantic graph;
locating edges in the topological semantic map that connect any two of the identified one or more nodes in the topological semantic map;
building a subset of the topological semantic map by maintaining the identified one or more nodes and the identified one or more edges, and removing other nodes and edges of the topological semantic map;
identifying one or more connected topological semantic graphs in the subset of the topological semantic map; and
in accordance with a determination that a respective connected topological semantic graph in the subset of the topological semantic map has at least a predefined number of nodes, including the respective connected topological semantic graph in the one or more candidate topological semantic graphs.

14. The electronic device of claim 13, wherein comparing the plurality of keypoints on the sequence of consecutive frame to the plurality of three-dimensional map points of the environment includes performing a geometric verification, which is realized by PnP followed by graph based optimization.

15. A non-transitory computer readable storage medium storing a plurality of programs for execution by an electronic device having one or more processing units, wherein the plurality of programs, when executed by the one or more processing units, cause the processing units to perform operations comprising:
capturing, by a camera moving in an environment, a sequence of consecutive frames at respective locations within a portion of the environment;
constructing a first topological semantic graph corresponding to the portion of the environment based on the sequence of consecutive frames; and
in accordance with a determination that the topological semantic graph includes at least a predefined number of edges:
searching, in a topological semantic map of the environment, one or more candidate topological semantic graphs corresponding to the first topological semantic graph;
for a respective candidate topological semantic graph of the one or more candidate topological semantic graphs, searching, in a joint semantic and feature localization map, for a keyframe corresponding to the respective candidate topological semantic graph, wherein the keyframe captures objects in the environment corresponding to nodes of the respective candidate topological semantic graph; and
computing a current pose of the camera based on the keyframe.

16. The non-transitory computer readable storage medium of claim 15, wherein the topological semantic graph includes:
a plurality of nodes with a respective node corresponding to a representation of an object located in the portion of the environment, wherein the object is captured and recognized from the sequence of consecutive frames; and
a plurality of edges with a respective edge connecting two respective nodes of the plurality of nodes, wherein the two respective nodes connected by the respective edge correspond to two respective objects captured and recognized on a same frame of the sequence of consecutive frames.

17. The non-transitory computer readable storage medium of claim 15, wherein the topological semantic map of the environment includes semantic information of the environment, and each of the one or more candidate topological semantic graphs is a connected subgraph of the topological semantic map.

18. The non-transitory computer readable storage medium of claim 15, wherein computing the current pose of the camera based on the keyframe includes comparing a plurality of keypoints on the sequence of consecutive frames to a plurality of three-dimensional map points of the environment corresponding to the keyframe; and determining the current pose of the camera based on a result of the comparing and known camera poses associated with the plurality of three-dimensional map points of the environment.

19. The non-transitory computer readable storage medium of claim 15, wherein the joint semantic and feature localization map comprises:
a semantic localization map that maps a plurality of representations of the objects in the environment to a plurality of keyframes captured in the environment; and
a feature localization map that maps a plurality of three-dimensional map points in the environment to the plurality of keyframes captured in the environment.

20. The non-transitory computer readable storage medium of claim 15, wherein searching, in the topological semantic map, for the one or more candidate topological semantic graphs corresponding to the first topological semantic graph includes:
for a respective node of the first topological semantic graph, identifying one or more nodes in the topological semantic map that share a same object identifier with that of the respective node of the first topological semantic graph;
locating edges in the topological semantic map that connect any two of the identified one or more nodes in the topological semantic map;
building a subset of the topological semantic map by maintaining the identified one or more nodes and the identified one or more edges, and removing other nodes and edges of the topological semantic map;
identifying one or more connected topological semantic graphs in the subset of the topological semantic map; and
in accordance with a determination that a respective connected topological semantic graph in the subset of the topological semantic map has at least a predefined number of nodes, including the respective connected topological semantic graph in the one or more candidate topological semantic graphs.
